(19) United States
(12) Patent Application Publication
(10) Pub. No.: US 2018/0165974 A1
(43) Pub. Date: Jun. 14, 2018

(54) VEHICLE COLLISION PREVENTION

(71) Applicants: Anthony BONKOSKI, Ann Arbor, MI (US); Isaac OLSON, Grandville, MI (US); Jonathan BENDES, Tenafly, NJ (US); Ryan MORTON, Ann Arbor, MI (US); Thomas K. BRADY, Three Rivers, MI (US); SkySpecs LLC, Ann Arbor, MI (US)

(72) Inventors: Anthony Bonkoski, Ann Arbor, MI (US); Isaac Olson, Grandville, MI (US); Jonathan Bendes, Tenafly, NJ (US); Ryan Morton, Ann Arbor, MI (US); Thomas K. Brady, Jr., Three Rivers, MI (US)

(21) Appl. No.: 15/577,671

(22) PCT Filed: May 27, 2016
(86) PCT No.: PCT/US2016/034668

§ 371 Date: Nov. 28, 2017

Related U.S. Application Data
(60) Provisional application No. 62/168,684, filed on May 29, 2015.

(51) Int. Cl. G08G 5/04; G08G 5/00; G08G 1/16

(52) U.S. Cl. CPC G08G 5/045; G08G 5/0021; G08G 1/16; G08G 5/0078; G08G 5/0091

(57) ABSTRACT

A method for collision avoidance includes receiving a maneuver command, obtaining observations from one or more sensors, generating one or more constraints based on the observations, combining the maneuver command and the one or more constraints to generate a constrained maneuver command that deviates from the maneuver command for collision avoidance, sending the constrained maneuver command to a controller. The method can include modifying motion of a vehicle based on the constrained maneuver command to maneuver with collision avoidance.

### CROSS REFERENCE TO RELATED APPLICATION

This application claims priority to and benefit of U.S. Provisional Patent Application No. 62/168,684, filed May 29, 2015, which is incorporated by reference herein in its entirety.

### BACKGROUND

### 1. Field

The present disclosure relates to aircraft control systems, more specifically to collision prevention systems and methods.

### 2. Description of Related Art

As unmanned vehicles become more common, it becomes increasingly important to have a scalable, drop-in solution for collision prevention. Unmanned vehicles are or will be used in many different environments and for any number of applications, including, for example, military reconnaissance, search and rescue, industrial inspection, package delivery, emergency services, film production, general photography, and humanitarian aid. Moreover, the hardware requirements may vary greatly from one application to another. For example, for industrial inspection of a pipeline, it may be necessary to use small vehicles that can fit into and maneuver through small areas. For a search and rescue mission, however, it may be necessary to use larger vehicles capable of moving objects or handling a large payload. No matter the environment or application, though, all vehicles must remain aware of surroundings and find a way to deal with obstacles.

Unmanned vehicles can crash for an assortment of reasons, including, for example, pilot error, battery loss, or hardware malfunction.

### SUMMARY

A method for collision avoidance includes receiving a maneuver command, obtaining observations from one or more sensors, generating one or more constraints based on the observations, combining the maneuver command and the one or more constraints to generate a constrained maneuver command that deviates from the maneuver command for collision avoidance, sending the constrained maneuver command to a controller. The method can include modifying motion of a vehicle based on the constrained maneuver command to maneuver with collision avoidance.

The observations can include environmental data received from one or more environmental sensors and an attitude estimate received from one or more attitude sensors. Obtaining observations can include detecting one or more obstacles around the vehicle.

The method can further include discretizing an area around the vehicle into a plurality of bins. The method can further include associating the one or more obstacles with the plurality of bins.

Generating the one or more constraints can include determining state estimates of each of the one or more obstacles. Determining the state estimates can include determining distance and velocity of the one or more obstacles.

The distance and velocity of the one or more obstacles can be determined based on changes of a closest point in the bin over time. In certain embodiments, determining the distance and velocity of the one or more obstacles can include running an iterative closest point algorithm on at least one of a single return from a sensor or groupings of observations received from the one or more sensors.

The method can further include determining constraints based on the state estimates. In certain embodiments, the method can further include determining a repulsion force. The method can further include combining the maneuver command with the one or more constraints and the repulsion force to generate the constrained maneuver command.

Generating the constrained maneuver command may comprise utilizing keypoints. In certain embodiments, generating the constrained maneuver command comprises solving a constrained optimization problem. The vehicle can be one of an unmanned vehicle and an optionally-piloted vehicle.

A system for collision avoidance (e.g., for aircraft or any other suitable vehicle) can include a processor coupled to a memory, the memory having instructions stored thereon that, when executed by the processor, causes the processor perform a method as described herein.

The one or more sensors the system can be operatively connected to can include at least one of an environmental sensor and an attitude sensor.

In certain embodiments, the system can be embodied in a module that is configured to be operatively connected between a remote control receiver and the controller to allow retrofit onto an aircraft. The system can be embodied in any other suitable configuration (e.g., as part of a controller of an aircraft).

A non-transitory computer readable medium includes instructions stored thereon that, when executed by a processor, cause the processor to perform a method as described herein.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures.

FIG. 1 shows an illustrative control architecture system for a vehicle, according to an embodiment herein.

FIG. 2 is a schematic view of an exemplary baseline control architecture.

FIG. 3A shows an illustrative schematic of a control architecture according to an embodiment herein.

FIG. 3B shows an illustrative schematic of a control architecture according to a different embodiment herein.

FIG. 4 shows an illustrative schematic of a control architecture according to another embodiment herein.

FIG. 5 shows an illustrative schematic of a control architecture according to another embodiment herein.

FIGS. 6A-6D show an exemplary schematic for generating constraints from obstacle observations according to an embodiment herein, such that:

FIG. 6A shows an exemplary top-down representation of a vehicle's movement relative to obstacles;

FIG. 6B shows the area around the vehicle represented by a plurality of buckets;

FIG. 6C shows a representation of the relative distance to and velocity of the obstacles; and

FIG. 6D represents the amount of force allowed in different directions based on the relative velocity of and direction to the obstacles.

FIG. 7 shows an exemplary method of generating a constraint validity region, according to an embodiment herein.

FIG. 8 shows an illustrative process flow for implementing the system 100 of FIG. 1 according to an embodiment herein.

FIG. 9 shows an illustrative method of generating constraints according to an embodiment herein.

FIG. 10 shows an illustrative process for generating constraints using an object detection methodology, according to an embodiment herein.

FIG. 11 shows an illustrative process for combining constraints and desired command, according to an embodiment herein.

### DETAILED DESCRIPTION

The following discussion is presented to enable a person skilled in the art to make and use the exemplary disclosed embodiments. Various modifications will be readily apparent to those skilled in the art, and the general principles described herein may be applied to embodiments and applications other than those detailed below without departing from the spirit and scope of the disclosed embodiments as defined herein. Accordingly, the disclosed embodiments are not intended to be limited to the particular embodiments shown, but are to be accorded the widest scope consistent with the principles and features disclosed herein. For example, while various embodiments described herein relate to unmanned aerial vehicles, embodiments herein may be used for any type of vehicle, including manned or unmanned, human-controlled, semi-autonomous, or fully-autonomous, and on any terrain, including land, air, and water.

Generally, an unmanned aerial system (UAS) or unmanned aerial vehicle (UAV) moves via motion commands, which communicate a desire for actuation, but not all possible commands lead to collision-free trajectories. The obstacles in question may range in size from giant walls and the ground down to branches and wires. In fact, UASs on the market can be quite easily commanded to collide with any of these obstacles. The economic and social benefits of UAS cannot be fully realized until these collisions can be repeatedly prevented. Limiting or preventing such collisions can open up opportunities in various commercial industries, including: package delivery, industrial inspection, film production, general photography, etc.

Embodiments herein present solutions to avoiding a crash caused by failing to adequately detect or move to avoid an obstacle. Generally, an UAV moves via motion commands from a pilot, either human or computerized, which communicates a desire for actuation. Not all possible commands, however, lead to a collision-free trajectory and may cause collisions with any number of obstacles. An obstacle may range in size from giant walls and the ground down to small branches and wires. Moreover, an obstacle, such as a bird or another UAV, may be a moving obstacle that could be on an unpredictable path and may make sudden changes in direction and speed. Moreover, a rogue, careless, or unsuspecting pilot can easily command an unmanned vehicle to collide with any of these obstacles.

Disclosed embodiments can also enable consumer applications, such as action sports photography. For example, existing UAVs can follow a snowboarder (or other action sports participants) down a mountain, but the UAV can easily crash into obstacles if the participant does not stay in obstacle-free spaces.

Furthermore, operation of existing UAVs is limited to wide-open spaces, e.g., high in the sky and out in open fields. Embodiments herein allow UAVs to get up-close-and-personal with the objects of the world.

An UAV's motion can be made safe by observing the local environment using on-board sensors and modifying the desired motion commands to avoid obstacles. Embodiments herein output a motion command that most closely resembles the desired command (i.e., a maneuver command), while achieving a set of safety constraints. A system according to an embodiment herein can allow full control, i.e., follows the desired command, on collision-free trajectories, but gradually reduces, or constrains, the control authority as obstacles become more dangerous. Embodiments herein are sensor, payload, vehicle, and hardware agnostic. Sensor data is used to constrain an input command for a vehicle running on hardware and/or software, including payloads, processors, and supporting interconnections.

Embodiments herein can:
smoothly and continuously transition between multiple flight commands, e.g., transition between a raw input from user and a modified safe command;
enable collision avoidance as a drop-in module—which is enabled because the collision avoidance system is agnostic to the external system;
safely modify input commands by constraining the input commands. By constraining, rather than overriding, the input command (e.g., from human pilot), the system is as safe as possible, while still moving towards the goals of the input command.

Terminology used herein may be defined as follows:

Remotely Controlled Vehicle (R/C): A flying craft that operates under direct human control, where said human pilot is not on-board the vehicle.’

Unmanned Aerial Vehicle (UAV): A flying craft that flies without an on-board pilot and has autonomous features allowing it to do some operations beyond typical R/C vehicles. For example, a UAV without a human in-the-loop for normal flight operations can be completely controlled by one or more computer(s).

Unmanned Aerial System (UAS): A UAV coupled with the supporting systems, e.g. the pilot (if applicable), the ground control station, the communication systems, the preflight checklists, etc., that allow the UAV to conduct flight operations.

Small Unmanned Aerial System (sUAS): A small UAS, which typically operates in the “last 400 feet”, i.e., not high in the sky, and often does not require an airport runway to takeoff/land. Thus, sUAS are generally more agile than larger UAS, allowing operations in closer proximity to obstacles, giving the possibility for many commercial applications.

Obstacle: Anything that introduces a disturbance to an sUAS's intended flight path. Obstacles take many forms, such as physical artifacts. e.g., walls and people, dynamic artifacts, e.g., air turbulence, or even harsh electromagnetic environments that cause sensor interference. An obstacle may also refer to an imaginary construct, for example, an airspace boundary or any other suitable imaginary boundary (e.g., the position of which is cross-referenced in a database as a function of GPS position).

Collision: A violation in which the aircraft comes into contact with an obstacle.

Crash: A collision that results in a flight-ending, or major flight-altering, course correction that the pilot (or other controlling authority) did not command.

Near Collision: A safety violation whereby the aircraft nearly collides with an obstacle, i.e., being within a preset threshold to an obstacle. The threshold could be based on distance, time-to-collision, or any other metric; may also be based on the skill or comfort level of the pilot.

Optimal Pilot: One who controls an aircraft with perfect knowledge of the dynamics and state of the vehicle. Such a theoretical pilot could skirt the boundaries of safety while still remaining safe, where the slightest error results in a near collision.

Unsafe Trajectory: A vehicle trajectory whereby if not corrected (and kept constant) would result in a near collision, even if an optimal pilot is in control.

Bin/Bucket: A discrete range of potential data values. For this work, bin/bucket refers to a bounded range of angle values, relative to an inertial frame centered somewhere on the vehicle. For example, a bin might correspond to ±1° from its center, which is located at 10° left of forward and 5° above the horizon.

Constraint: A limit on a command that prevents any (known) unsafe trajectories. One possible type of constraints is a maximum allowable force/velocity/acceleration in a particular direction. For example, if a wall exists in front of an sUAS, forward commands may be limited, e.g. to ½ of normal range, or explicitly disallowed to prevent an unsafe trajectory towards the wall.

Radial Constraint: A constraint that uses radial bins to limit commands based on a single angle parameter, i.e., the yaw angle corresponding to the desired motion direction/velocity.

Controller: A method that drives some state to a desired state. For example, if a particular algorithm is configured to keep the vehicle X meters away from obstacle, the state is the distance to closest obstacle and the controller would generate commands (for the flight controller) to push the vehicle toward these safe states.

Cluster: A grouping of data points that ideally correspond to the same entity, e.g., a rigid-body.

Repulsion Force: The physical force needed to be exerted by the vehicle's flight controller in order to modify a trajectory from unsafe to safe,

Ground Control Station (GCS): A command station whereby a human operator may interact with the vehicle. Technically, a transmitter is a GCS, but the term is generally used to refer to a more substantial user interface and/or processing system, such as a laptop/tablet where a user may enter desired commands, such as GPS waypoints and configuration parameters.

Aspects of disclosed embodiments relate generally to preventing a vehicle from colliding with an obstacle. Moreover, though disclosed embodiments are described with respect to unmanned aerial vehicles, a person skilled in the art will recognize that the disclosed systems and methods may be used for any type of vehicle, including manned or unmanned, human-controlled, semi-autonomous, or fully-autonomous, and on any terrain, including land, air, and water. Disclosed systems and methods include hardware-enabled software systems that are sensor, payload, vehicle, and hardware agnostic and can augment existing off-the-shelf components. As such, the disclosed collision avoidance system can be used as a drop-in module for any vehicle running on any hardware, including payloads, processors, and the supporting interconnections.

By way of example, disclosed systems and methods may be used to prevent an aircraft (e.g., such as an unmanned aerial vehicle (UAV)) from crashing into a wall or other obstacle. A UAV may be a flying craft that flies without an on-board human pilot and has autonomous features allowing it to do various operations beyond a typical remote controlled vehicle. For example, a UAV without a human in-the-loop for normal flight operations can be completely controlled by one or more computers. Alternatively, an aircraft may have one or more humans on board that co-exist with the autonomous features, for example, in an optionally piloted vehicle. A UAV may be part of an unmanned aerial system (UAS) in which the UAV is coupled with supporting systems, including, for example, a pilot, a ground control station, a communications system, and preflight checklists that allow the UAV to conduct flight operations. While embodiments are described herein that refer to a UAV, it is understood that the embodiments described herein can be applied to any suitable aircraft, manned, unmanned, or otherwise.

Disclosed embodiments may be used to prevent a UAV from colliding with an obstacle while maintaining a trajectory or path that is most consistent with the instructions from the pilot. An obstacle may be anything that introduces a disturbance to a UAV's intended flight path. Obstacles can take many forms and can include, for example, physical artifacts such as walls and people, dynamic artifacts such as air turbulence or electromagnetic environments that cause sensor interference, or imaginary constructs such as airspace boundaries. One way to avoid colliding with an obstacle is to provide the vehicle with sensors that observe the vehicle's environment. Data from the sensors may then be used to modify motion commands received by the vehicle from a pilot. In the case of imaginary constructs, the sensors can include a location detection unit (e.g., a GPS) and a source of information (e.g., an airspace database and/or navigational chart such as a VFR sectional/Terminal Area Chart) that allows cross-referencing of position versus the location of a boundary of the imaginary construct.

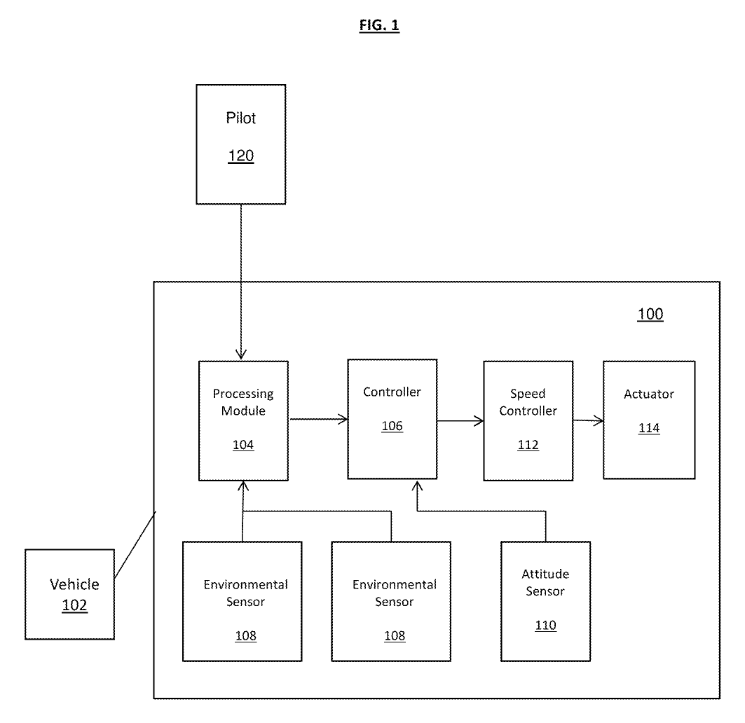

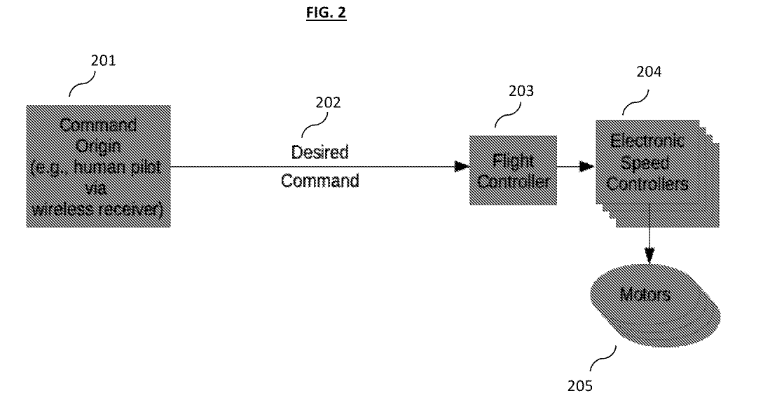

Referring to the figures. FIG. 1 illustrates one example of control architecture system 100 for a vehicle 102 which may be implemented in a baseline control architecture as shown in FIG. 2, according to an embodiment herein.

An exemplary baseline control architecture is shown in FIG. 2 for a typical UAV. The desired commands 202 may originate off-board, i.e., via wireless communications, or from an on-board auto-pilot or optionally-piloted system 201. The flight controller 203 uses the desired command 202 to compute the individual motor speeds to be sent to electronic speed controllers 204 in order to produce the forces and moments that will achieve the motion specified in the desired command 202 using motors 205.

Referring back to FIG. 1, the inputs to the system 100 may include a desired motion command of the system, attitude estimate, and environmental sensor data. The desired motion command is the primary input for embodiments herein and can be used to determine how the vehicle would move assuming there are no obstacles. The attitude sensor determines the roll & pitch of the vehicle and the environmental sensors provide observations of the local environment. The output from system 100 is a constrained maneuver (safe) motion command. Therefore, if the user commands the robot to pitch, i.e., move, forward into a wall, the command is corrected such that the component of the user command pointed toward the wall is removed. It is important to note that embodiments herein do not simply choose between the two possible commands, i.e., original and safe, which is the topology used by many commercial collision avoidance systems. Instead, the output is a smooth combination of the (user's) desired command and safety constraints, thus producing an output that is both safe and the most similar to the desired command. For example, a forward-right command with a wall in front of the vehicle will result in removing the forward component of the command and thus the vehicle will strafe right along the wall.

Among other components, the vehicle 102 may include processing module 104, controller 106, environmental sensor 108, attitude sensor 110, speed controller 112, and actuator (e.g., motor) 114. Vehicle 102 is controlled via desired motion commands sent by pilot 120. A desired motion command determines how the vehicle would move according to commands from pilot 120 assuming there are no obstacles. The desired motion command is most often generated by a user controlling the vehicle via a remote control transmitter, e.g., the Spektrum® DX9. The message from these transmitters often affects, in some direct or indirect way, the vehicle's roll, pitch, yaw and a vertical velocity (relative to current attitude).

In addition to transmitters, the desired motion command may come from an autonomous planner, configuration file, macros, prerecorded flight paths, or any other medium that produces motion commands intended to be sent to a flight controller. For example, a user may click on an autonomous planning application running on a laptop/tablet, sending GPS, or other suitable devices that are configured to send commands to the sUAS. Additionally, an autonomous planner may track a moving object, e.g., a snowboarder, and command the flight controller to follow the object.

Pilot 120 may be external or internal to the vehicle. Furthermore, pilot 120 may be a human or non-human operator. Moreover, pilot 120 may be a remote or onboard auto-pilot system. For example, pilot 120 may be a human using a wireless remote control transmitter that communicates with a wireless receiver onboard the UAV. A message from a transmitter may, for example, affect, in a direct or indirect way, the UAV's roll, pitch, yaw, and vertical velocity relative to the vehicle's current attitude.

Along with the desired motion command received from pilot 120, vehicle 102 receives additional data from various sensors. Environmental sensors 108 provide observations of vehicle 102's local environment. Environmental Sensors 108 may be used to observe various properties of obstacles in the vicinity of vehicle 103. These properties may include dynamic properties relative to vehicle 102 such as, for example, distance to the obstacle or velocity of the obstacle or absolute properties of the obstacle such as, for example, shape. Sensor data may be returned directly from an environmental sensor 108 or indirectly computed. For example, a distance can be indirectly generated from multiple camera images or by combining data from multiple sensors.

Environmental sensors 108 may encompass many types of sensors and configurations. Different types of sensors may include, for example, scanning laser range-finders, cameras, spectrum pixel sensors, infrared range-finders, ultrasonic range-finders, pressure sensors, and flash LiDAR. Different arrangements of environmental sensors 108 are also possible, including varying the position, orientation, quantity, and types of the sensors on vehicle 102. The arrangement of a sensor may allow the disclosed system to understand the data from the sensor. Environmental sensors 108 may be used to observe distances and/or velocities to obstacles in the vicinity of the UAV. These distances may be returned directly from the sensor or indirectly computed, e.g., distance can be computed from multiple camera images or by combining data from multiple sensors. The invention encompasses many possible sensors and configurations, i.e., the position, orientation, quantity, and type of the sensor, on the vehicle.

In addition to environmental sensors 108, vehicle 102 may also include attitude sensors 110 to generate an attitude estimate for determining the orientation of the vehicle, which may include the roll and pitch of the vehicle. The attitude sensors 110 may be the same sensors used to gather environmental data, a different set of sensors from environmental sensors 108, or a combination of sensors used to gather environmental data and sensors not used to gather environmental data. For example, attitude sensor 110 may be an Inertial Measurement Unit (IMU), which may use a combination of accelerometers, gyroscopes, and magnetometers. An attitude estimate may include the roll and pitch of the UAV, which may be used to properly transform and understand the environmental sensor data from environmental sensors 108. e.g., with respect to the ground. An exemplary attitude sensor 110 used to estimate attitude is an IMU such as the Microstrain® 3DM-GX3-25, which combines accelerometers and gyroscopes to produce the orientation of the vehicle. Additional filtering and/or state estimation may be required for an accurate attitude estimate from raw sensor data. The attitude estimate may be provided by the flight controller, a sensor directly connected to the processing module, or elsewhere.

One advantage of including attitude sensors 110 is to transform and understand environmental data based on the vehicle's orientation. For example, attitude data may be used to understand the position of vehicle 102 relative to the ground and various obstacles. Additional filtering or state estimation may be necessary for an accurate attitude estimate from raw sensor data. Moreover, the attitude estimate may be provided by controller 106, a sensor directly connected to processing module 104, or elsewhere.

Controller 106 is configured to control each of the individual actuators 114 that produce forces to cause vehicle 102 to move. Controller 106 uses a safe motion command to generate commands for the actuators 114 in order to produce the forces and moments that will achieve the motion specified in the command. For example, if actuator 114 is a motor, speed controller 112 may be used to manage the speed of the motor and continually attempt to maintain the desired motor speed.

Processing module 108 may be implemented as software, hardware or a combination of both. Processing module 108 takes a plurality of inputs, including a desired motion command, and outputs a constrained command (e.g., a constrained maneuver command) based on those inputs. A constrained command is a command that is altered from a desired motion command based on external factors such as, for example, sensor data. That is, a constraint is a limit on a command that prevents any known unsafe trajectories. One possible type of constraint is a maximum allowable force, velocity, or acceleration in a particular direction. For example, if a wall exists in front of a vehicle, forward commands may be limited to/of normal range or explicitly disallowed to prevent an unsafe trajectory towards the wall. Thus, a constrained command allows full control by pilot 120 via the desired motion command while ensuring a collision-free trajectory but may also gradually reduce, or constrain, the command authority as one or more obstacles become more dangerous. For example, if pilot 120 commands vehicle 102 to move forward into a wall, the command is corrected such that the component of the user command pointed toward the wall is removed.

One advantage of this control structure is smooth and continuous transitions between multiple flight commands such as, for example, between raw input from pilot 120 and a modified, safe command generated by a system according to an embodiment herein. That is, disclosed embodiments do not simply choose between the two possible motion commands, i.e., desired and safe, but instead generate a smooth combination of the desired command and safety constraints, thus producing an output that is both safe and the most similar to the desired command.

For example, if a wall is in front of vehicle 102 and a desired command instructs vehicle 102 to move forward and to the right, a resulting safe motion command will remove the forward component of the command and cause the vehicle to avoid the wall by strafing right along the wall. By constraining, rather than overriding, the desired motion command from pilot 120, vehicle 102 is allowed to travel as close to the route as pilot 120 intended while avoiding collisions with obstacles.

The sensor data combined with the desired motion command may include data from environmental sensors 108, attitude sensors 110, or both. Moreover, a constrained command may be, for example, a safe motion command sent to controller 106. Alternatively, controller 106 may be incorporated into processing module 108 and the constrained command may be commands for each actuator 114.

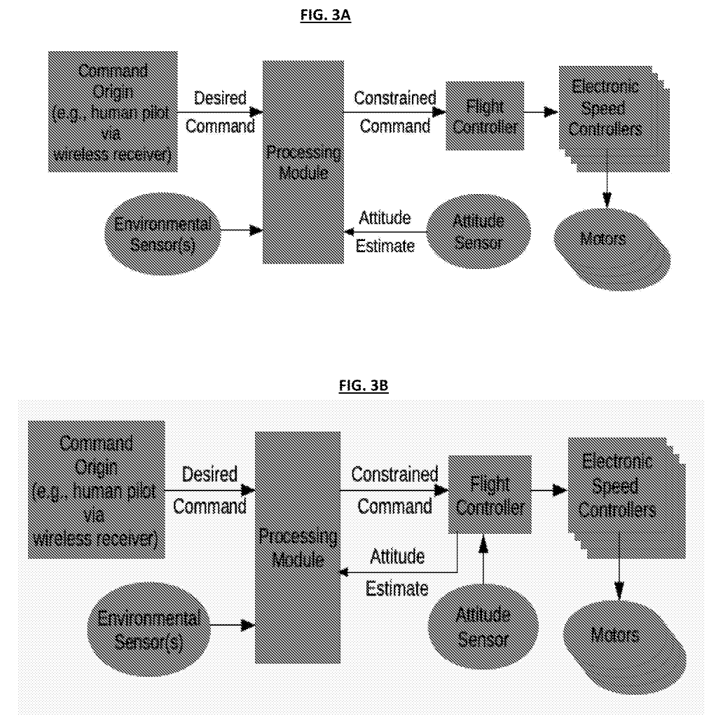

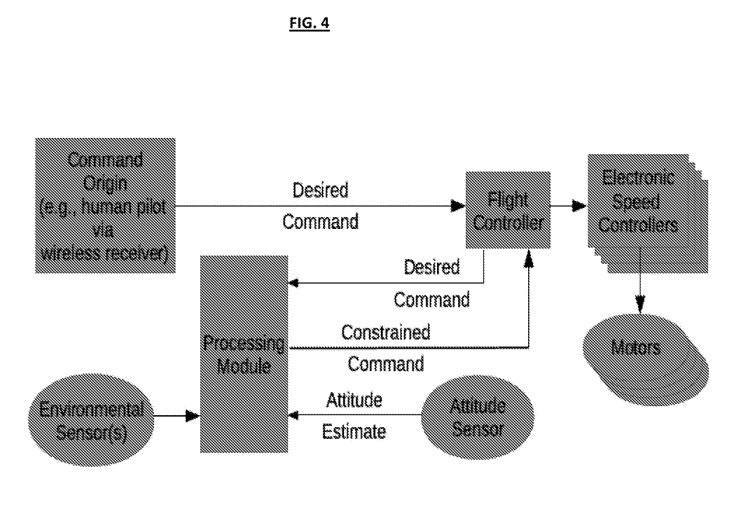

FIGS. 3-5 show illustrative schematics of control architectures according to various embodiments herein. As shown in FIG. 3A, a desired command can originate from a pilot (e.g., pilot 120 of FIG. 1). The desired command can then be sent to a processing module (e.g., processing module 104), which receives as input, data from environmental sensors (e.g., environmental sensors 108) and attitude estimate from attitude sensor (e.g., attitude sensor 110). The processing module then sends a constrained command to a flight controller (e.g., controller 106) which sends data to electronic speed controllers (e.g., speed controller 112) to manage the speed of the motors (e.g., actuators 114) and continually attempt to maintain the desired motor speed.

FIG. 3B shows a variation from the embodiment of FIG. 3A in which the attitude sensor may send data to the flight controller instead of the processing module. The flight controller may then send attitude estimates to the processing module.

FIG. 4 shows a variation from the embodiment of FIG. 3A in which the desired command is sent to the flight controller instead of the processing module. The flight controller then sends the desired command to the processing module.

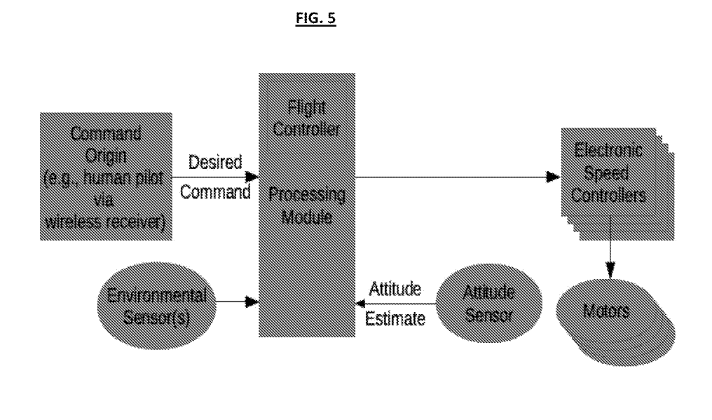

FIG. 5 shows a variation from the embodiment of FIG. 3A in which the flight controller is implemented as part of the processing module.

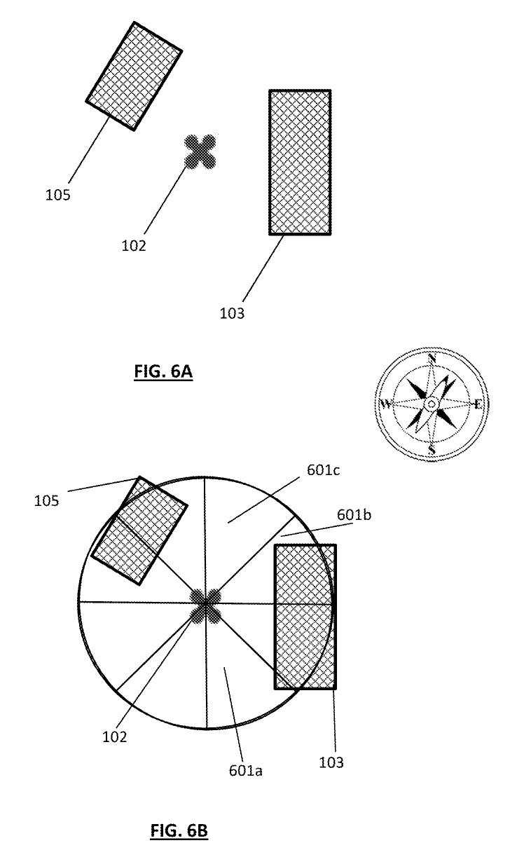

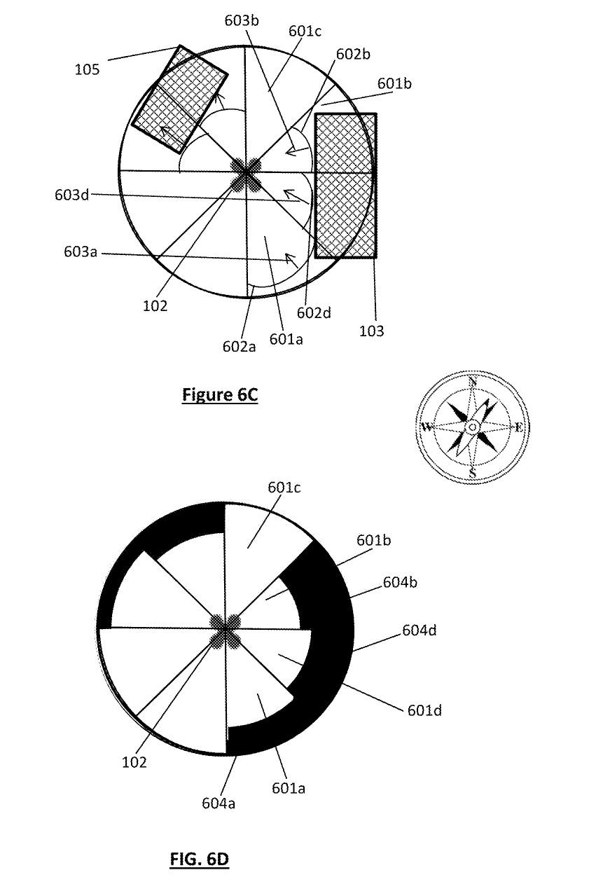

In the embodiments herein, to generate a safe motion command, a discrete set of potential movements for a vehicle 102 may be assigned to one or more buckets. FIGS. 6A-6D show illustrative representations of a process for generating constraints from obstacle observations. As used herein, a bucket may be a discrete range of potential data values that relate to discrete two-dimensional or three-dimensional areas around the vehicle 102. Buckets may be a bounded range of angle values relative to an inertial frame centered somewhere on the vehicle. For example, a bucket may correspond to ±1° from the vehicle's center, which may be located at 10° left of forward and 5° above the horizon. Buckets may overlap to correct for noise or other environmental factors.

As buckets represent a multi-dimensional area around a vehicle, any data retrieved or generated by environmental sensors 108 can also be associated with one or more buckets corresponding to the location of an obstacle causing the sensor data to be generated. For example, in FIGS. 6A-6D, buckets 601a. 601b, and 601c are buckets that relate to spherical angles around vehicle 102. If an obstacle is located in the space corresponding to bucket 601a, the sensor data is accordingly associated with bucket 601a.

The resolution of the discretization can be as fine or coarse as desired. For example, the area surrounding vehicle 102 may be divided into 10 or 1200 buckets. Moreover, the buckets do not need to be uniform, with some buckets bigger than others and varying in distribution around the vehicle. The specific number, size, and distribution of buckets may be determined for optimization and performance related to differing use cases, including for computational limitations. Optimization may be a mapping of sensor data into spherical coordinates and a discretization of the angles (θ and φ) to provide efficient computation.

Once discretized, the safety of each bucket (i.e., movement in the direction of each bucket) can be generated based on the sensor data associated with the bucket. As such, the command authority that pilot 120 has in the direction of the bucket may be determined based in part on the sensor data. Command authority, a type of constraint, in a particular direction may refer to one or more metrics such as, for example, the maximum amount of force, velocity, or acceleration in that direction. Further optimization of the command authority may be performed based on information associated with nearby buckets for smoothing, noise reduction, and to provide a broader determination of safety in that direction. For example, sensor noise, e.g., the small fluctuations in the distance returned from a sensor, may lead to large changes in constraints due to non-linearities in the distance-to-constraint function. When a desired motion command is input into processing module 104, whether directly from pilot 120 or indirectly through one or more other modules, the command can be associated with one or more buckets and combined with the one or more constraints associated with the buckets to produce a constrained motion command.

Smoothing may be accomplished by a variety of methods, including, but not limited to, a Kalman Filter. Particle Filter, or Markov Chain Monte Carlo. This information may then be shared between buckets to provide smoothed constraints with limited data. This sort of sharing of data may be accomplished in different domains, including a distance and velocity domain or a force domain. By way of example, smoothing may be performed by first associating sensor data with one or more buckets. Then, the state of each bucket may be calculated by combining any new sensor data, which may include, for example, the distance and velocity of an obstacle relative to the vehicle, with prior state information for the bucket using a Kalman Filter. As a result, individual observations and states are probabilistically smoothed. Based on the new state, force constraints in each bucket may be calculated and the forces may be blurred among nearby buckets up to a maximum distance using, for example, dot products of constraint vectors.

FIG. 6A is an exemplary top-down representation of vehicle 102 moving east toward obstacle 103 and away from obstacle 105. Obstacles 103 and 105 may be stationary or moving. Environmental data corresponding to obstacles 103 and 105 is collected by environmental sensors 108 (e.g., environmental sensors 108 of FIG. 1) associated with vehicle 102.

As illustrated in FIG. 6B, the space around a vehicle 102 may be represented by eight discrete buckets. Each bucket may have environmental data associated with it based on whether an obstacle is present in the bucket. For example, environmental data associated with obstacle 103 is mapped to buckets 601a and 601b. Bucket 601c, however, does not have any environmental data associated with it because an obstacle is not present in the space represented by bucket 601c. Alternatively, bucket 601c may have environmental data associated with it if the system is optimized to include information associated with nearby buckets for smoothing, noise reduction, or to provide a broader determination of safety in that direction.

To determine which obstacles may be a potential threat to vehicle 102, object detection may be used to determine characteristics of obstacles based on environmental and attitude data. A threat may include, for example, an obstacle such that a potential desired command would result in a collision by causing vehicle 102 to come into contact with the obstacle. Moreover, a large threat may result in a crash, which may be a collision that results in a flight-ending or major flight-altering course correction that pilot 120 did not command. Alternatively, a threat may also include an obstacle such that a potential desired command would result in a near collision by causing vehicle 102 to nearly collide with an obstacle based on some predetermined condition such as, for example, being within a preset threshold to an obstacle. This threshold may be based on a number of different factors, including, for example, distance, time-to-collision, or any other metric; the threshold may also be based on factors such as skill or comfort level of pilot 120. Disclosed embodiments prevent vehicle 102 from an unsafe trajectory that would, if not corrected and kept constant, result in a near collision, even if an optimal pilot is in control. An optimal pilot is a theoretical pilot that controls vehicle 102 with perfect knowledge of the dynamics and state of the vehicle. Such a theoretical pilot could test the boundaries of safety while still remaining safe, such that the slightest error results in a near collision.

One way to prevent an unsafe trajectory is by object detection to determine characteristics of potential obstacles such as, for example, the position, shape, or velocity of an obstacle based on environmental data and to interpret the data to further determine whether data associated with multiple bins represent one obstacle or multiple obstacles. Several methods may be used to detect and track various obstacles, including clustering observed environmental data into rigid bodies. A cluster is a grouping of data points that ideally correspond to the same entity, including a rigid body. As a result observations of obstacles around the vehicle based on environmental data may be clustered as rigid bodies that move together. A probabilistic tracker may be used to further help determine whether particular observations represent a single obstacle (i.e., should be clustered) or separate obstacles that are near one another (i.e., should not be clustered).

An obstacle detection method may require the state of each obstacle to be tracked, including, for example, variables such as an obstacle's position, velocity, and shape. Thus, vehicle 102 may be tracking a set of obstacles, each specified by the aforementioned state. Each of the variables, and sub-variables, within the state may include some error. Therefore, an assumption, such as a Gaussian assumption, may be made indicating existence of a mean and covariance for each obstacle. Thus, there may be a mean, or best guess, position (e.g., x, y, and z), velocity (e.g., vx, vy, vz), and shape (e.g., some 3D depiction of shape, such as a voxel array). Additionally, each of these variables, under Gaussian assumption, has some uncertainty, which, for example, for position and velocity may be explained by a covariance matrix, and for shape may be explained by a probabilistic voxel array.

Using the probabilistic model for each obstacle, new information may be probabilistically associated with an existing obstacle. A Kalman Filter, Extended Kalman Filter, Particle Filter, or any other filter may then be used to track the obstacle. These filters may use the prior state (e.g., mean and uncertainty) along with new observations (sensor data and a model for observation uncertainty) to update the state over time. Once observations are clustered and tracked, an obstacle's predicted trajectory may be determined absolutely or within a certain bounded range.

Based on object detection, disclosed embodiments may generate constraints based on relative characteristics between vehicle 102 and an obstacle such as, for example, the relative velocity of and distance to the obstacle. FIG. 6C is a representation of the relative distance to and velocity of obstacles 103 and 105. Arcs 602a, 602b, and 602d represent the radial distance between vehicle 102 and the portion of obstacle 103 within each respective bucket. For example, the radial distance between vehicle 102 and obstacle 105 in bucket 601a is larger than the distance between vehicle 102 and obstacle 105 in bucket 601b. Vectors 603a, 603b, and 603d represent the radial velocity of obstacle 103 relative to vehicle 102. For example, the radial velocity between vehicle 102 and obstacle 105 in bucket 601a is smaller than the radial velocity between vehicle 102 and obstacle 105 in bucket 601b.

FIG. 6D is another example illustrating vehicle 102 and obstacles 103 and 105 and represents the amount of force allowed in different directions based on the relative velocity of and direction to the obstacles. A proportional-integral-derivative controller may be used to determine the allowable force in any one direction. Even though FIG. 6D is a representation of forces, any measurable metric may be used such as, for example, velocity or acceleration. Shaded portions 604a. 604b, and 604d represent reductions in command authority for the associated bucket. For example, vehicle 102 has reduced command authority in the direction of buckets 601a, 601b, and 601d. Furthermore, the reduction in command authority is greater in the direction of bucket 601d than in the direction of bucket 601a. Moreover, the command authority for vehicle 102 in the direction of bucket 601c is unconstrained, thus giving pilot 120 full command of the UAV in the direction of bucket 601c. As a result, the maximum allowable force in each direction may be generated based on the radius from vehicle 102 to the edge closest to the vehicle of the shaded region. That is, FIG. 6d represents the amount force is constrained and command authority is limited in the direction of any bucket that includes an obstacle.

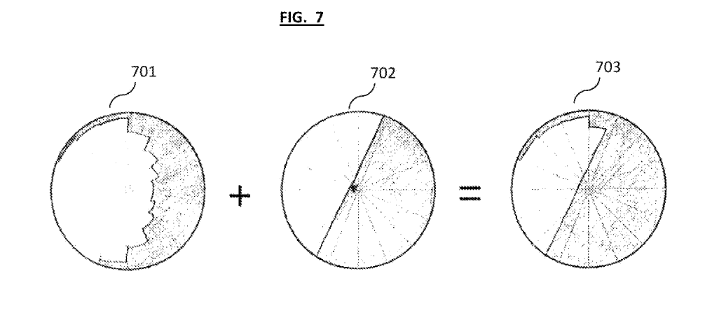

FIG. 7 illustrates an exemplary method of generating a constraint validity region. A repulsion region is a region surrounding vehicle 102 that will cause a desired command to be constrained in any direction within the region and produce a force in another direction. Repulsion forces are constraints that may have an associated sign (+/−). While a constraint places a maximum value or magnitude on a maneuver, a repulsion force places a minimum value or magnitude on the maneuver, e.g., in the direction away from an obstacle when the UAV has moved too close to an obstacle or is approaching an obstacle too quickly. As shown, 702 is a representation of a repulsion region. A repulsion command, or vector, represents the command that would be output from the system if the pilot commands zero movement. In turn, a repulsion region represents all possible desired commands that do not satisfy the zero movement constraint. For example, if an obstacle that is very close and to the left of a vehicle 102, the constraint may require the vehicle to go 20% throttle to the right (positive roll). Any desired command that satisfies the at least 20% throttle to the right is valid. Alternatively, any command that does not satisfy the 20% right constraint would fall within the repulsion region and the desired command would be constrained towards the right to satisfy the 20% right constraint.

FIG. 7 shows a representation of a constraint validity region 703 for vehicle 102 based on obstacles 103 and 105. To generate the constraint validity region 703, the constraint representation of FIG. 6D, represented as 701 in FIG. 7, is combined with the repulsion region 702 of FIG. 7. As such, the desired command may be augmented to ensure it satisfies the repulsion force. This augmentation, if required, is done by adding a component to the desired command that is parallel to the repulsion force. That is, the minimum length component in a vector sum approach is added to modify the desired command such that the command satisfies the repulsion force. As a result, the desired and repulsion satisfying augmented commands are minimally changed, while the orthogonal components remain unmodified. The adjusted desired command may then be compared to a repulsion force vector from the bucket.

Based on the constrained command, valid keypoints may be determined. A keypoint is a point of a bucket in which the repulsion region intersects the bucket's boundary or a point within a bucket that is the boundary between a valid and invalid command. For example, if the desired command is within a bucket that is not completely in the repulsion region, the keypoint may be a scaled version of the desired command that creates a constrained command within a valid force range. As a result, a keypoint may coincide with a constrained command that may be vector in the same direction of the desired command but with a different magnitude. In another example, if a constrained command that is merely a scaled version in the same direction of the desired command does not result in a command within a valid force region, then the direction of the constrained command may also be adjusted. As such, a keypoint for the constrained command may lie on the boundary between two buckets or on a radial arc at the constraint distance within the bucket.

If multiple keypoints are generated, the best keypoint is then selected. The best keypoint is the keypoint that coincides with the constrained command that best aligns with the desired command. This can be done, for example, by taking the dot product between a normalized desired command and a normalized vector to the keypoint. The selection of best keypoint may be either a function of the difference in angle between the desired command and keypoint vector, a function of the magnitude difference between the desired command and keypoint vector, or a function of both the differences in magnitude and angle between the desired command and keypoint vector.

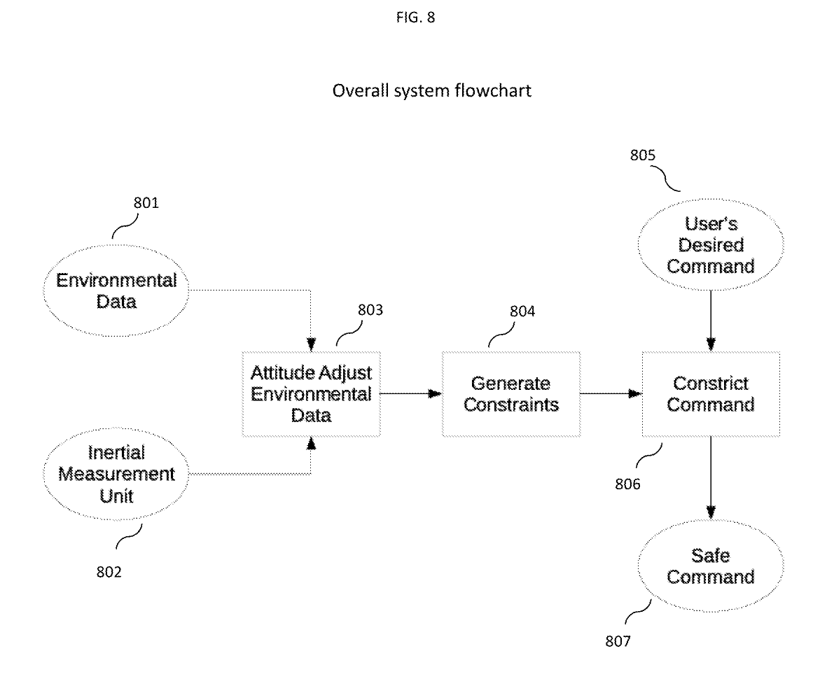

FIG. 8 shows an illustrative process flow for implementing the system 100 of FIG. 1 according to an embodiment herein. An exemplary method for collision avoidance may include receiving environmental data 801 (e.g., from environmental sensors 108 of FIG. 1), receiving attitude data from an IMU 802 (e.g., attitude sensors 110 of FIG. 1), attitude adjusting the environmental data 803, generating constraints 804, receiving a desired command 805, and combining the desired command 805 with the constraints 804 to generate a safe (constrained) command 806, which may then be used to modify motion of the UAV.

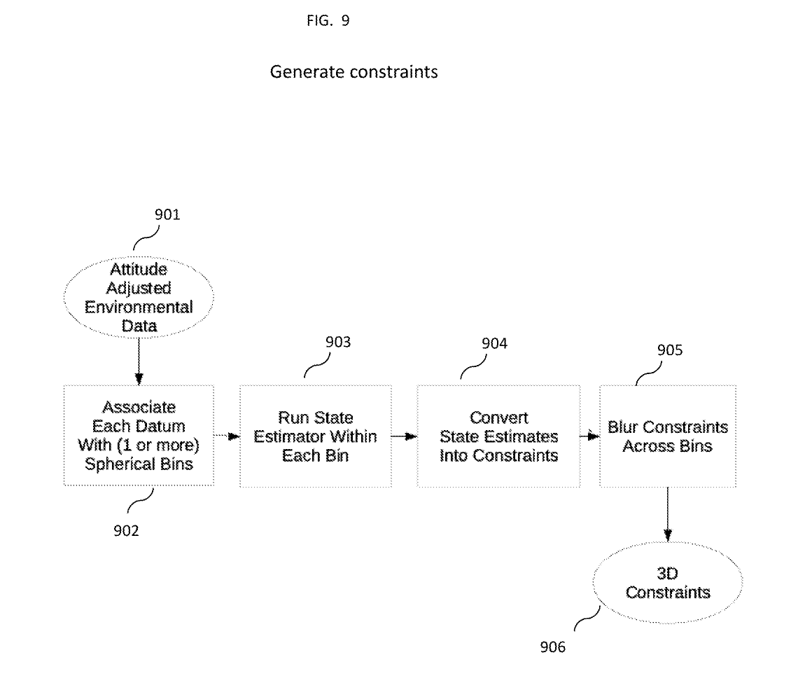

FIG. 9 shows an illustrative method of generating constraints according to an embodiment herein. To generate constraints, a vehicle equipped with sensors observes its environment by collecting sensor data to detect any nearby obstacles. Combining sensor data with attitude data to obtain attitude adjusted environmental data 901, the vehicle can then transform the sensor data to detect the relative velocity and position of the obstacles. This transformed sensor data can then be mapped or associated into one or more discrete buckets/bins based on the position of the obstacle. This mapping may be done by discretizing the possible motion commands into buckets and associating the transformed environmental data into one or more buckets 902. The potential movement of the vehicle can be put into bins, or buckets, relating to the spherical angles around the vehicle. The resolution of the discretization can be as fine as desired, e.g., 1000 or 10 total bins, and does not need to be uniform, i.e., the size and distribution of bins may independently vary. Specifying the discretization parameters is primarily an optimization/performance decision and not a core component of the invention. However, once discretized, the safety of each bin, i.e., movement in that direction, can be ascertained from sensor data in that cell (and possibly nearby cells) to determine the control authority that a user has in that direction.

The position and velocity of the most dangerous observed obstacle for each bin may be determined by a state estimator 903 by, for example, modeling measurement uncertainty using a Kalman Filter state estimator. This allows outliers, noise, and erroneous states to be rejected and position and velocities to be transformed into force constraints 904.

Then constraints can be smoothed or blurred across bins to reduce errors 905 in discretization and ensure each bucket fulfills neighboring bins' constraints. Information from nearby bins may be combined, e.g., for smoothing and noise reduction, to provide a broader picture of the safety in that direction. Next, a repulsion force may be determined via combining constraints from all buckets by generating the angle and magnitude for a repulsion force. If an inescapable situation is detected-that is, if there is no possible repulsion force that can prevent a collision-a failsafe may be triggered.

The users command can be mapped to a bin and combined with the constraint, i.e., command authority, in that bin to produce an output command. That is, once the constraints and a repulsion force are determined, they may be combined with the desired command to generate a constrained command 906. A constrained command may be generated by first determining a command that meets both the repulsion force and individual bucket constraints, while maximizing the similarity to the desired command. To do this, the constraints may be considered as a connected geometric shape, either in 2D or 3D space, with a point on the vehicle as the origin. Commands within the shape are acceptable commands that lead to a safe trajectory that avoid a collision. Commands outside the geometric shape, however, lead to unsafe trajectories and are rejected. Regions within the geometric shape are further restricted by removing the regions that do not provide a valid repulsion force. Once all invalid commands—commands that lead to a collision—are removed, the command most aligned with the desired command and within the valid region of the geometric shape may be selected. If any further mission-specific restrictions are present, such as, for example, restrictions requiring slower movement near people, those may also be factored into the constrained command. As a result of the above, the constrained command may then be sent to the flight controller, allowing the vehicle to move on a safe trajectory. It should be noted that in certain embodiments, the constraints may be blurred across bins before converting the state estimates into constraints, i.e., 905 may be performed before 904.

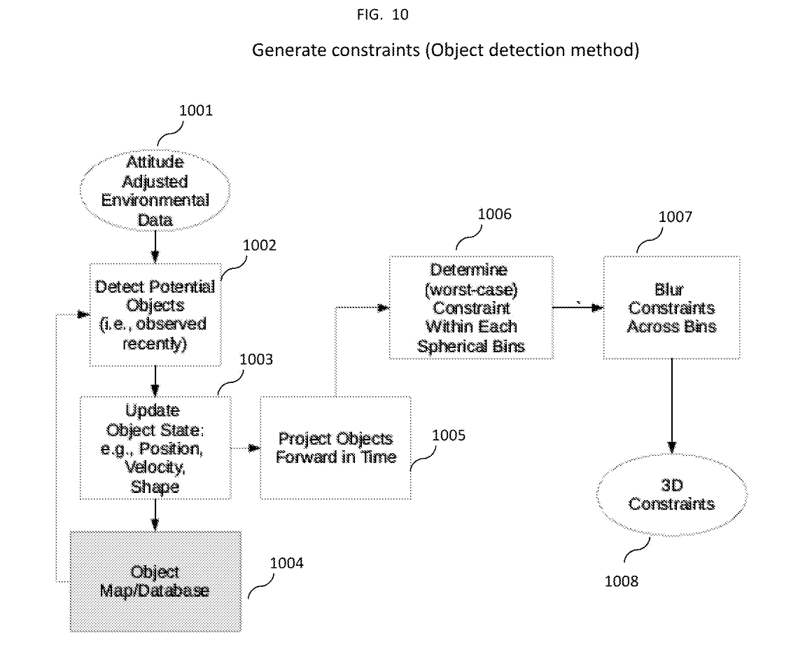

FIG. 10 shows an illustrative process for generating constraints according to an object detection methodology used in various embodiments herein. Collisions can be prevented by detecting individual obstacles around the vehicle and tracking their position, shape and/or velocity. Environmental data from sensors can be attitude adjusted using attitude data as described above to obtain attitude adjusted environmental data 1001. There are various methods to detect and track obstacles, such as clustering observations into rigid bodies. The individual sensor observations of obstacles around the vehicle can be clustered, ideally as rigid bodies that move together. Object detection using one or more sensors may be performed continuously or intermittently over a period of time such that objects can be detected 1002, the state of the object can be updated based on new information 1003 and the data can be mapped and/or stored in a database and updated accordingly 1004. It is unknown which observation should be clustered (e.g., same object or just close-by), but a probabilistic tracker can adequately determine the clusters. Once a cluster is known and tracked (e.g., position and velocity relative to the vehicle), the object's future predicted trajectory can be determined, or at least practically bounded 1005. The position and/or velocity of the most dangerous observation affecting each bin can be determined 1006. A state estimator can be used to determine the position and velocity in each bin, e.g., using a Kalman Filter state estimator. Outliers, noise, and erroneous states are rejected via a model of measurement uncertainty. The position and velocities are then transformed into force constraints through a controller, such as a PID controller. The states between bins are blurred to smooth constraints, reduce discretization error, and ensure that each bin fulfills neighboring bins' constraints 1007. The repulsion force can then be determined as described above in the context of FIG. 7. For example, by combining constraints/forces from all bins, and calculating the angle for a repulsion force or calculating the magnitude for a repulsion force. Optionally, certain embodiments may detect an inescapable situation and trigger fail-safe.

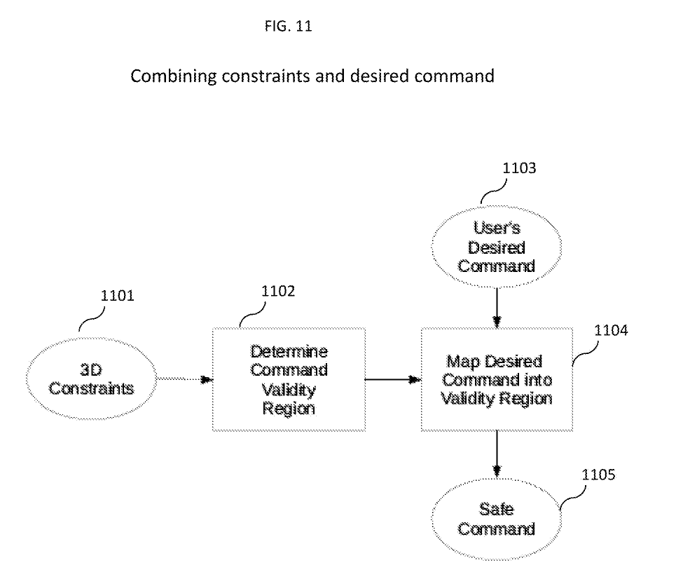

FIG. 11 shows an illustrative process for combining constraints and a desired command which may be used in conjunction with process described in FIG. 9 or 10 above.

A command validity region 1102, e.g., a command motion that meets both the repulsion force and individual bin constraints, can be determined from the constraints 1101, while maximizing similarity to desired command 1103. The constraints can be considered as a connected geometric space/shape, i.e., an area in 2D, a volume in 3D, with the vehicle at the origin. Commands within the space/shape are acceptable, while commands outside the space/shape lead to unsafe trajectories (see FIG. 7). This validity space/shape can be further restricted by removing the regions that violate the repulsion force. The desired command 1103 may be mapped to the validity region 1104. The command within the validity space/shape that most aligns with the intent of the original desired command can be selected as the safe command 1105. Optionally, the command can be further restricted to meet mission/regulatory objections. e.g., require slower movements near the ground, people, etc.

Accordingly, the observation step in embodiments herein is used to determine which “obstacles” are nearby, along with their distance from, and velocity, relative to, the vehicle. An obstacle may be represented by: (1) a “bucket/bin”, where observations from onboard sensors are rastered into a discretized area around the vehicle; (2) a single observation from an onboard sensor (e.g., 1 of the 16,000 laser returns in a single scan, or a single return from an ultrasonic sensor): or (3) a clustering of observations determined to represent a single rigid body, formed through a clustering algorithm such as K-means clustering. If the onboard sensor(s) are only capable of providing information about the obstacle's distance from the vehicle, further processing is required to calculate the obstacle's velocity.

For instances in which the obstacles are represented as buckets/bins, an obstacle's velocity can be calculated by virtue of rasterizing the observations into a bucket. For example, if the closest point in a bucket at time step t₀ was determined to be 5 meters, and at time t₁ was determined to be 4 meters, and t₁−t₀=1 second, the obstacle's velocity is 1 m/s toward the UAV.

For instances in which obstacles are represented as a single observation or by clustering observations, the velocity of the obstacle can be calculated, for example, through an iterative closest point algorithm, which attempts to match each point or cluster observed at time t₀ to the points or clusters observed at time t₁. Once the observations from the two time steps have been associated, the velocity of the points or clusters can be calculated readily. Note that in (1) above, the velocity of the UAV is inherently interpreted as being toward the vehicle, whereas with (2) and (3), the velocity of the obstacle can be represented as any 3-dimensional velocity vector.

Once environmental and/or attitude data is obtained from the observation step, state estimates may be generated. To generate state estimates, distance and velocity information can be extracted from the sensor data. Since most sensors only return distance, not velocity, of an obstacle, the same obstacle can be observed multiple times over a window of time, noting the time between each observation. The velocity of an obstacle/object is the change in distance divided by the change in time.

Concluding that an obstacle is indeed the same obstacle that was observed in previous time steps is known as a data association problem. Data association may be performed in a variety of ways. For example, data association can be done by discretizing the area around the vehicle into bins and assuming that whenever an obstacle is observed in a bin, it's the same obstacle in that bin every time subsequently. The velocity can be calculated based on how the closest point in the bin changes over time. Another way to perform data association can include using either groupings of observations from sensor data (clusters), or single returns from a sensor, an iterative closest point algorithm or similar can be run on the observation(s) in order to determine which objects in a certain time step correspond to their counterpart objects in a previous time step.

A goal of the constraint step is to, when necessary, alter a command from a user or auto-pilot to make it safe, such that the vehicle won't collide with an obstacle. These obstacles, following the observation step, can have state estimates associated with each obstacle, e.g., a position, velocity, and shape associated with them. A controller (for example a PID controller as described above) is used to calculate a force or acceleration repulsion or constraint in the direction of the vehicle. The command is altered such that, so long as a collision is avoidable, it satisfies the constraints and repulsions applied on the vehicle's motion by every obstacle in view.

One such method for applying these constraints and repulsions involves keypoint calculation, as described above. A second method involves formulating each obstacle as if it were a flat plane, approaching the vehicle. A plane is defined by the equation ax+by+cz=d, where the vector

$$[ \begin{matrix}a \\ b \\ c\end{matrix} ]$$

is the normal vector to the plane and d is the distance of the plane from the origin. In an embodiment, matrices A, D may be constructed as follows:

$$A = [ \begin{matrix}{a}_{1} & {b}_{1} & {c}_{1} \\ {a}_{2} & {b}_{2} & {c}_{2} \\ … & … & … \\ {a}_{n} & {b}_{n} & {c}_{n}\end{matrix} ] , \\ D = [ \begin{matrix}{d}_{1} \\ {d}_{2} \\ … \\ {d}_{n}\end{matrix} ] ,$$

Here, aᵢ, bᵢ, cᵢ, dᵢ, iϵ{1 . . . n} are the coefficients of the planes defining obstacles 1 through n. The vector defined by {aᵢ, bᵢ, cᵢ} is the vector that points from the robot to an obstacle, and d is the output of the controller that is run on that obstacle. A solution for the output command, subject to all constraints and repulsions, while being most similar to the input maneuver command may be obtained by finding a command X that minimizes ∥X−U∥, where X is the output command, and U is the input command, subject to the constraint: Ax≤D. Problems of this type are known as constrained optimizations problems, and may be solved with a variety of linear or quadratic programming techniques such as interior point, branch and bound, or with Lagrange multipliers.

As will be appreciated by those skilled in the art, aspects of the present disclosure may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit.” “device.” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

FIG. 1 is intended to provide a brief, general description of an illustrative and/or suitable exemplary environment in which embodiments of the above described present invention may be implemented. FIG. 1 is exemplary of a suitable environment and is not intended to suggest any limitation as to the structure, scope of use, or functionality of an embodiment of the present invention. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

The methods and systems of the present disclosure, as described above and shown in the drawings, provide for measuring sea state based on the dynamics of a moving object. While the apparatus and methods of the subject disclosure have been shown and described with reference to preferred embodiments, those skilled in the art will readily appreciate that changes and/or modifications may be made thereto without departing from the scope of the subject disclosure.

What is claimed is:

1. A method for collision avoidance, comprising:
receiving a maneuver command;
obtaining observations from one or more sensors;
generating one or more constraints based on the observations;
combining the maneuver command and the one or more constraints to generate a constrained maneuver command that deviates from the maneuver command for collision avoidance;
sending the constrained maneuver command to a controller.

2. The method of claim 1, wherein the observations comprise environmental data received from one or more environmental sensors and an attitude estimate received from one or more attitude sensors.

3. The method of claim 1 or claim 2, wherein obtaining observations comprises detecting one or more obstacles around the vehicle.

4. The method of any one of claim 3, further comprising discretizing an area around the vehicle into a plurality of bins.

5. The method of claim 4, further comprising associating the one or more obstacles with the plurality of bins.

6. The method of claim 5, wherein generating the one or more constraints comprises determining state estimates of each of the one or more obstacles.

7. The method of claim 6, wherein determining the state estimates comprises determining relative distance and velocity of the one or more obstacles.

8. The method of any one of claim 7, wherein the distance and velocity of the one or more obstacles are determined based on changes of a closest point in the bin over time.

9. The method of claim 7, wherein determining the distance and velocity of the one or more obstacles comprises running an iterative closest point algorithm on at least one of a single return from a sensor or groupings of observations received from the one or more sensors.

10. The method of any one of claims 7-9, further comprising determining constraints based on the state estimates.

11. The method of any one of claims 1-10, further comprising determining a repulsion force or repulsion forces.

12. The method of claim 11, further comprising combining the maneuver command with the one or more constraints and the repulsion force to generate the constrained maneuver command.

13. The method of claim 12, wherein generating the constrained maneuver command comprises utilizing keypoints.

14. The method of claim 12, wherein generating the constrained maneuver command comprises solving a constrained optimization problem.

15. The method of any one of claims 1-14, wherein the vehicle is one of an unmanned vehicle and an optionally-piloted vehicle.

16. A system for collision avoidance, comprising:
a processor coupled to a memory, the memory includes instructions stored thereon that, when executed by the processor, causes the processor to:
receive a maneuver command;
obtain observations from one or more sensors;
generate one or more constraints based on the observations;
combine the maneuver command and the one or more constraints to generate a constrained maneuver command that deviates from the maneuver command for collision avoidance; and
send the constrained maneuver command to a controller;
wherein the controller is configured to modify motion of a vehicle based on the constrained maneuver command to maneuver with collision avoidance.

17. The system of claim 16, wherein the one or more sensors comprises at least one of an environmental sensor and an attitude sensor.

18. The system of claim 16 or claim 17, further comprising a speed controller configured to receive input from the controller and manage a speed of one or more motors to modify the motion of the vehicle.

19. The system of any of claims 16-18, wherein the system is embodied in a module that is configured to be operatively connected between a remote control receiver and the controller to allow retrofit onto an aircraft.

20. A non-transitory computer readable medium, comprising instructions stored thereon that, when executed by a processor, cause the processor to:
receive a maneuver command;
obtain observations from one or more sensors;
generate one or more constraints based on the observations;
combine the maneuver command and the one or more constraints to generate a constrained maneuver command that deviates from the maneuver command for collision avoidance; and
send the constrained maneuver command to a controller of an aircraft.
